(19) United States
(12) Patent Application Publication
(10) Pub. No.: US 2018/0173840 A1
(43) Pub. Date: Jun. 21, 2018

(54) COMPUTER AIDED-METHOD FOR A QUICK PREDICTION OF VORTEX TRAJECTORIES ON AIRCRAFT COMPONENTS CHECKING HIGH PRESSURE GRADIENTS AND HIGH DRAG FRICTION COMPONENTS

(71) Applicant: Airbus Operations, S.L., Getafe (ES)

(72) Inventors: Nuno Vinha, Getafe (ES); David Vallespin Fontcuberta, Getafe (ES); Valentín De Pablo Fouce, Getafe (ES); Eusebio Valero, Getafe (ES)

(21) Appl. No.: 15/840,620

(22) Filed: Dec. 13, 2017

(30) Foreign Application Priority Data
Dec. 15, 2016 (EP) 16382604.3

(51) Int. Cl. G06F 17/50

(52) U.S. Cl. CPC G06F 17/5095; G06F 17/5009; G06F 17/5086

(57) ABSTRACT

A computer-aided method suitable for assisting in the design of an object zone such as a CROR engine of an aircraft subjected to high vorticity and/or low static pressure fields when moving inside a flow field by providing suitable seed points for constructing vortex core lines in a fluid data model of the environment of said object zone and a system based in said method. The method steps are: a) Obtaining a dataset of candidate seeds containing all the cells or points satisfying a condition of the pressure gradient in the direction of the flow or a condition of the drag friction coefficient at the solid boundaries; b) Updating the previous dataset of candidate seeds with all the cells or points satisfying the equation not used for obtaining the dataset in step a).

### RELATED APPLICATION

This application claims priority to European Patent Application 16382604.3 filed Dec. 15, 2016, is incorporated by reference.

### FIELD OF THE INVENTION

The present invention refers to a method to assist in the design of components with parts moving relative to a flow, particularly Counter Rotating Open Rotor (CROR) engines installed in aircraft, in their endeavour to reduce noise levels, drag, vibrations, and fatigue loads, due to vortex-surface interaction.

### BACKGROUND OF THE INVENTION

In recent years Counter Rotating Open Rotor (CROR) engines have become of prime interest in the aeronautical industry, in search for more efficient aircraft configurations. Amongst the biggest drawbacks in these particular engine types are the high levels of noise generated, both broadband and tonal, and design focus is on trying to reduce. As it is well known a major contribution to tonal noise is caused by the first stage rotor blade tip vortices impacting on the second stage rotor. The impact condition is also undesirable from the aerodynamic and structural point of view, as it penalizes drag, and increases significantly vibrations and fatigue loads nearby the impact regions.

Thanks to the development in Computational Fluid Dynamics (CFD) techniques and the exponential growth in computational power today it is possible to obtain detailed flow behaviour predictions under normal operating conditions.

A new problem arises from these types of simulation, which is the large amount of data that needs to be processed to be able to derive valuable conclusions. In particular, the simulations focusing on noise prediction require very small time steps and large meshes which increases the data reduction process and analysis on the part of the designers. Most methodologies in noise prediction move from the CFD analysis directly to noise propagation models based on pressure data around known noise sources which gives quantitative noise information at relevant distances around the source at high computational costs.

Surprisingly, a precise and unique mathematical definition of a vortex does not exist in literature.

A vortex was defined by Lugt in 1979 as “the rotating motion of a multitude of material particles around a common center” [1]. Later on, Robinson provided the following definition: “a vortex exists when instantaneous streamlines mapped onto a plane normal to the vortex core exhibit a roughly circular or spiral pattern, when viewed from a reference frame moving with the center of the vortex core” [2]. Another definition of a vortex came from Portela [3], considering that “a vortex is comprised of a central core region surrounded by swirling streamlines”.

The lack of consensus for a rigorous and unique definition of a vortex gave rise to the development of several vortex detection algorithms. Kolar in [4] enumerates more than twenty vortex detection methods developed in the last three decades. The majority of these methods consider that any vortical structure contains a core/skeleton line, and a swirling fluid motion around that line. Hence, two main categories of vortex extraction methods can be found in literature:
The ones that look for vortex core lines, or the imaginary center of rotational motion, are usually called line-based (LB) methods.
The ones that search for vortex core regions or for “regions of influence” of the vortex core line [5]. These schemes are commonly known as region-based (RB) methods, mainly allowing the visualization of iso-surfaces of a certain scalar field that represent the vortex core boundary.

According to [6], RB methods are easier to implement and require less computational burden in comparison to LB schemes. However, the latter can provide a more accurate representation of the vortex, especially when the distance between two individual structures is considerably small. This is the biggest limitation of RB methods, with higher relevance for strongly curved rotating structures.

In LB methods, the region of rotational influence of a vortex can additionally be estimated, using surface-based techniques. In [7] we can find several surface methods developed particularly for vortex visualization.

The vorticity-predictor pressure-corrector method is a well-known LB method, and it was introduced by Banks & Singer in 1995 [8]. The algorithm basically extracts streamlines of the vorticity field during a predictor step, correcting these predictions based on the local minimum pressure in a corrector step, and providing a more precise approximation of a vortex core skeleton. The method relies on both a low static pressure and a high vorticity magnitude criterion to investigate if a certain point belongs to a vortex skeleton. Nonetheless, and according to [8], it is possible to have regions with low pressure or with high vorticity magnitude without being associated with a vortex.

Examples of such cases are the flow downstream of an obstacle and a shear flow, respectively. Nevertheless, the authors believe that the combination of these two criteria is a powerful indication of the presence of a vortex.

The algorithm starts by an initialization step, which looks for possible candidate seeds at every grid point of the fluid domain. The initialization of the original Banks & Singer method [8] is based on arbitrary user inputs which may be inferred from thresholds of low static pressure and high vorticity magnitude. A good candidate point is thus a grid point that satisfies the two thresholds. The method also foresees corrections to the position of these candidate points, so that they are not constrained to the grid.

From the candidate points extracted during the pre-processing step, the algorithm starts developing the vortex core lines. At each iteration point, a predictor step is firstly applied, followed by a correction treatment, as we can observe in the following pseudocode (adapted from [6]):

1: locate seeds with low pressure P and
high vorticity magnitude |ω|
2: for all seeds do
3: repeat
4: compute ω_{I}, at current seed point pᵢ (FIG.1_1)
5: step in ωᵢ to predict next point p₁₊ᵢ (FIG.1_2)
6: compute ω₁₊ᵢ at predicted point p₁₊ᵢ (FIG.1_3)
7: procedure (find Pₘᵢₙ on plane ⊥ ω₁₊ᵢ (FIG.1_4)
8: if [symbol] (ω₁₊ᵢ, ω_{Pmin}) < limit then
9: correct predicted point p₁₊ᵢ to p_{Pmin}
10: else
11: quit corrector phase
12: end if
13: end procedure
14: until skeleton exits domain or is too long
15: end for

The steps comprising the original predictor-corrector method are schematically sketched in FIGS. 1(a) to 1(d):

1. Step 1: Compute the vorticity at a point of the vortex core.

2. Step 2: Step in the vorticity direction to predict the next point.

3. Step 3: Compute the vorticity at the predicted point.

4. Step 4: Correct to the pressure min. in the perpendicular plane.

Note that for the predictor and corrector steps the method uses only vector quantities.

The algorithm expects that any vortex core line stops growing when it starts leaving the fluid domain, and when the total arclength along a skeleton line is at least two times bigger than the highest grid dimension [8]. The method is also capable of eliminating redundant seeds, skeletons, and any spurious feeders that may appear during its computation. The present LB method can additionally be combined with techniques that provide a geometrical approximation of the shape of the vortex, from cross-sections of the vortex tubes in planes perpendicular to the imaginary core.

As explained before, the vortex lines start growing from a set of candidate points resulting from the initialization step. The original method makes the selection of candidates according to high vorticity and low static pressure threshold criteria. A candidate point is thus a grid point that satisfies exclusively these two thresholds. Normally this methodology works fine for simple academic test cases, with a low number of grid points. However, when dealing with a large scale industrial case with high flow complexity (such as the aircraft CROR engine, shown in FIGS. 2(a) and 2b), where each solution snapshot contains around 95 million points), the original initialization may return a huge amount of candidate points. This will directly penalize the subsequent predictor-corrector step, once it has to be started from each one of those candidate points, resulting in excessive and prohibitive computational burdens. Furthermore, by relying exclusively on those two threshold criteria, there is not a physical guarantee that the selected thresholds contain the most relevant features. As an example for the CROR case shown in FIGS. 2(a) to 2(c), by setting a threshold for cells whose vorticity magnitude is higher or equal to only 0.15% of the maximum vorticity of the computational domain, this criterion fails to extract cells related to the tip vortex emerging from the first rotating row. The output of the aforementioned vorticity threshold is only associated with the boundary layer of the rotating surfaces, where vorticity can also be high. Alternatively, for the lowest static pressure values of the domain, the corresponding threshold filter retrieves no more than points or cells located in low pressure zones of the blades. And for the present CROR test case, significant trial and error tests were required to correctly tune a static pressure threshold that allowed the extraction of cells or points related to tip vortices.

The original initialization process relies only on thresholds, and so there is always a user interference that cannot be avoided in the Banks & Singer method. Moreover, as the present CROR test case demonstrated, it is not a straightforward task for the designer/analyzer/engineer to correctly adjust thresholds relying on static pressure and vorticity magnitude. There are several flow regions apart from the tip vortices where the static pressure is low and the vorticity is high, reducing the probability of those two criteria to extract cells or points associated to tip vortices. Furthermore, the pressure and vorticity thresholds set for one case probably have to be changed for different flow problems.

The present invention is addressed to the solution of this problem, by increasing the probability of the Banks & Singer pre-processing step to find candidate cells or points that develop into a tip vortex core line.

### SUMMARY OF THE INVENTION

An embodiment of the invention is a computer-aided method suitable for assisting in the design of an object zone subjected to high vorticity and/or low static pressure fields when moving inside a flow field by providing suitable seed points for constructing vortex core lines in a fluid data model of the environment of said object zone.

The fluid data model comprises a CFD dataset and/or wind tunnel data and/or experimental volumetric data and/or flow field analytical data.

The computer-aided method can be employed to provide the candidate seeds from which vortex core lines develop, following the predictor step and the correction treatment of the above-mentioned Banks & Singer method or any other suitable Line-based (LB) method.

The computer-aided method comprises the following steps:

a) Obtaining a dataset of candidate seeds containing all the cells or points satisfying:
the condition dp/dX>dp/dX_{threshold}, being dp/dX the pressure gradient in the direction of the flow and dp/dX_{threshold} a suitable parameter for the object zone;
or the condition Cdf>Cdf_{threshold}, being Cdf the drag friction coefficient at the solid boundaries and Cdf_{threshold} a suitable parameter for the object zone.

b) Updating the previous dataset of candidate seeds with all the cells or points satisfying the condition not used for obtaining the dataset in step a).

The final dataset contains the above-mentioned candidate seeds.

It is another object of the invention to provide a system comprising a computer memory and processor for assisting in the design of an object zone subjected to high vorticity and/or low static pressure fields when moving inside a flow field by providing suitable seed points for obtaining vortex core lines in a fluid data model of the environment of said object zone.

The system comprises a fluid data model of the environment of said object zone and a computer-implemented module for identifying cells or points of the object zone following the steps of the above-mentioned method.

In an embodiment of said method and system the object is an aircraft.

In another embodiment of said method and system the object zone is a Counter Rotating Open Rotor (CROR) engine of an aircraft.

In another embodiment of said method and system the object zone is a Counter Rotating Open Rotor (CROR) engine of an aircraft and the fluid data model comprises an area covering the vortices generated by a blade tip of the first stage of the engine that impact the second stage of the engine.

The invention may be embodied as a computer-aided method to assisting in designing of an aircraft component subjected to high vorticity and/or low static pressure fields while moving through a flow field, the method comprising:

providing seeds for points in a fluid data model of vortex core lines generated by the aircraft component moving through the flow field, wherein providing the seeds includes:

(a) obtaining a first dataset of candidate seeds for each of the points satisfying:
(i) a condition dp/dX>dp/dX_{threshold}, wherein dp/dX is a pressure gradient in the direction of flow in the flow field and dp/dX_{threshold} is a predefined threshold level of dp/dX; or
(ii) a condition Cdf>Cdf,_{threshold,} wherein Cdf is a drag friction coefficient at solid boundaries of the aircraft component, and Cdf_{threshold} is a predefined threshold level of Cdf, and

(b) updating a second dataset of candidate seeds for all of the points including the points not used to obtain the first dataset. The second dataset may be a dataset of seeds for the points which is prior to the first dataset.

Other desirable features and advantages of the invention will become apparent from the subsequent detailed description of the invention and the appended claims, in relation with the enclosed drawings.

### BRIEF DESCRIPTION OF THE DRAWINGS

FIGS. 1(a) to 1(d) illustrate the four steps of the Banks & Singer pressure-predictor vorticity-corrector method (from [8]).

FIGS. 2(a) to 2(c) show the computational domain and the structured mesh of an aircraft CROR engine used in an embodiment of the invention.

FIGS. 3(a) and 3(b) show, respectively a volumetric dataset and the superficial dataset resulting from its projection illustrating the step 3 of the method according to this invention in a CROR engine case.

FIGS. 4(a) and 4(b) show the location of the extracted superficial points after performing step 6 of the method according to this invention, for two values of dp/dX in a CROR engine case.

FIGS. 5(a) and 5(b) show the location of the extracted superficial points after performing step 8 of the method according to this invention, for two values of C_{df} in a CROR engine case.

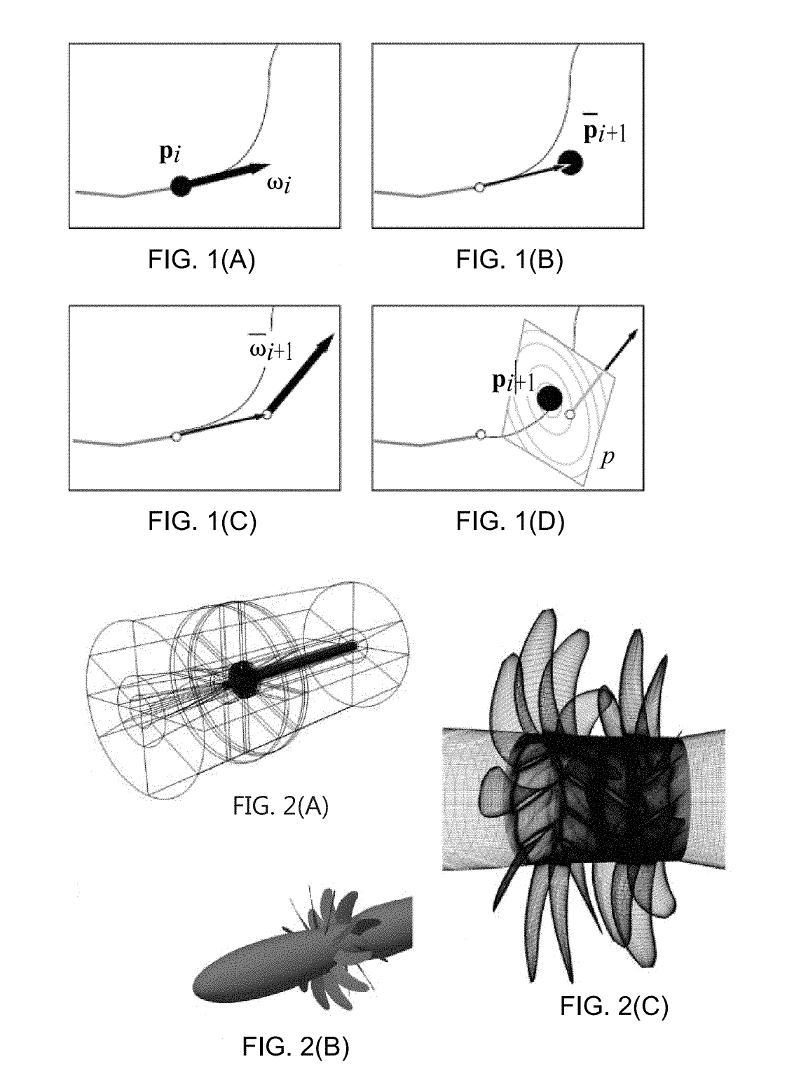

### DETAILED DESCRIPTION OF THE INVENTION

The method comprises the following steps:

Calculate the gradients of the three velocity components (Vₓ, V_{y}, V_{z}) and the static pressure gradient (∇p), at each cell or point of the computational domain.

Compute the pressure gradient in the direction of the flow (dp/dX), as the scalar projection of ∇p onto V:

$$\frac{dp}{dX} = \frac{∇ p \cdot V}{\vert V \vert} = \frac{( dp / dx ) {V}_{x} + ( dp / dy ) {V}_{y} + ( dp / dz ) {V}_{z}}{\sqrt{{V}_{x}^{2} + {V}_{y}^{2} + {V}_{z}^{2}}} \qquad ( 1 )$$

where X is the local direction of the flow.

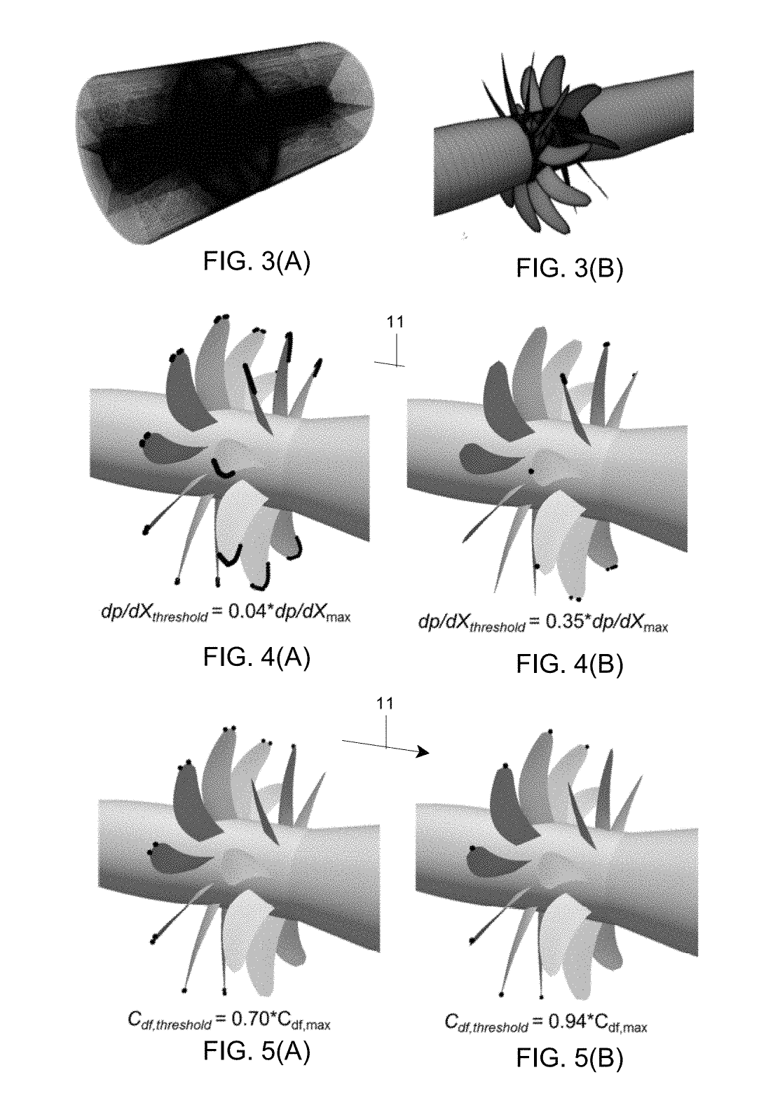

3. Project the volume information of the dataset that also contains the variables calculated in steps 1 and 2 into the matching superficial nodes. The result of this operation is a new superficial dataset, wherein the last layer of cells or points of the original volumetric dataset is projected towards the surface cells or points that are locally matching. This process is illustrated in FIGS. 3(a) and 3(b). At each cell or point of the superficial dataset created after step 3, approximate the nine single components of the stress tensor by:

$$\begin{matrix}{τ}_{ij} = - p {δ}_{ij} + μ ( \frac{{dV}_{i}}{{dx}_{j}} + \frac{{dV}_{j}}{{dx}_{i}} ) \\ where & ( 2 ) \\ {δ}_{ij} = \{ \begin{matrix}1 & if i = j \\ 0 & if i \neq j\end{matrix} & ( 3 )\end{matrix}$$

and where the dynamic viscosity μ is a property of the working fluid.

5. The drag friction coefficient is then calculated by means of the following equation:

$$\begin{matrix}{C}_{df} = {C}_{df , x} + {C}_{df , y} + {C}_{df , z} \\ with \text{:} & ( 4 ) \\ {C}_{df , x} = \frac{( {τ}_{xx} cos α cos β + {τ}_{yx} cos α sin β + {τ}_{zx} sin α ) \times {Normals}_{x}}{{S}_{ref}} & ( 5 a ) \\ {C}_{df , y} = \frac{( {τ}_{xy} cos α cos β + {τ}_{yy} cos α sin β + {τ}_{zy} sin α ) \times {Normals}_{y}}{{S}_{ref}} & ( 5 b ) \\ {C}_{df , z} = \frac{( {τ}_{xz} cos α cos β + {τ}_{yz} cos α sin β + {τ}_{zz} sin α ) \times {Normals}_{z}}{{S}_{ref}} & ( 5 c )\end{matrix}$$

and where α represents the angle of attack, β the angle of sideslip, S_{ref} the reference area, and Normals, the surface normals in the i-direction. After the present step, the parameters dp/dX and C_{df} must comprise the superficial dataset.

6. For the pressure gradient in the direction of the flow (dp/dX):
Define a positive threshold value for dp/dX (dp/dX_{threshold}).
Extract cells or points where dp/dX>dp/dX_{threshold} from the superficial dataset previously created in step 5.

7. Create a new dataset containing the candidate seeds resulting from the superficial cells or points extracted in step 6.

8. For the drag friction coefficient (C_{df}):
Define a positive threshold value for C_{df} (C_{df,threshold}).
Extract cells or points where C_{df}>C_{df,threshold} from the superficial dataset previously created in step 5.

9. The dataset previously created in step 7, which contains candidate seeds, is then updated with the information derived from the extraction in step 8. This final dataset contains the candidate seeds for the subsequent predictor/corrector phase of the Banks & Singer method.

The method according to this invention improves the quality and reduces the uncertainty of the original pre-processing step of the Banks & Singer method, which relies only on high vorticity and low pressure thresholds, as it increases the probability of the aforementioned LB method to find candidate cells or points that will develop into a tip vortex core line in the subsequent predictor/corrector phase. On the one hand, adverse pressure gradients in the direction of the flow induce the formation of the “separated” tip vortex from the first blade row. The extraction of cells or points where this parameter is higher than zero enhances thus the probability to find “good” candidate seeds, i.e. seeds that will evolve into a tip vortex core line. On the other hand, the method according to this invention searches also for surface cells or points where the drag friction coefficient is high, suggesting high local aerodynamic losses. For the example being considered with respect to a CROR problem, the formation of tip-vortices, but also a tip-vortex-blade impact condition, has a significant contribution to the overall aerodynamic losses of the system. With the combination of these two superficial aerodynamic parameters, a more intelligent selection of candidate seeds is granted, but also the quality of the initialization process becomes less dependent upon the human's selection of thresholds, in comparison to the thresholds of vorticity magnitude and static pressure of the original initialization.

The advantages introduced by the method according to this invention are presented in the following Table 1, for the example being considered with respect to a CROR CFD simulation. This table compares the number of points extracted with the original static pressure (P) and vorticity magnitude (|ω|) threshold method, with those extracted with parameters used by the method according to this invention (dp/dX and C_{df}), and provides information about if the extracted points are related with the tip vortex generated from the first blade row. The graphical information for threshold 1 and 3 of dp/dX and C_{df} is depicted in FIGS. 4(a), 4(b), 5(a) and 5(b), respectively (arrow 11 shows the flow direction).

Table 1 shows that the method according to this invention is much less sensitive to the selection of thresholds, when confronted to pressure and vorticity magnitude thresholds. For the latter, seeds associated with the tip vortex can only be extracted with a threshold in the order of 0.0003 the maximum vorticity magnitude of the computational domain. For the static pressure, only by setting a threshold from 6 times its minimum value inside the computational domain, the extraction of cells related with the tip vortex is possible. The method according to the present invention also enables a significant drop of the number of candidate seeds extracted, allowing thus an important reduction of the computational burden of the Banks & Singer method.

TABLE 1

| | Threshold on | | | |
|---|---|---|---|---|
| | P* | \|ω\|* | dp/dX | C_{df} |
| Threshold 1 | 6.0* Pₘᵢₙ | 0.0003* \|ω\|ₘₐₓ | 0.04* dp/dXₘₐₓ | 0.70* C_{df,max} |
| # Pts₁ | 10619111 | 19806357 | 6319 | 701 |
| Pts within tip | YES | YES | YES | YES |
| vortex from 1^{st} row | | | | |
| Threshold 2 | 5.0* Pₘᵢₙ | 0.1* \|ω\|ₘₐₓ | 0.17* dp/dXₘₐₓ | 0.82* C_{df,max} |
| # Pts₂ | 2357355 | 387408 | 2042 | 60 |
| Pts within tip | NO | NO | YES | YES |
| vortex from 1^{st} row | | | | |
| Threshold 3 | 3.5* Pₘᵢₙ | 0.8* \|ω\|ₘₐₓ | 0.35* dp/dXₘₐₓ | 0.94* C_{df,max} |
| # Pts₃ | 456848 | 84 | 702 | 60 |
| Pts within tip | NO | NO | NO | YES |
| vortex from 1^{st} row | | | | |

*with original Banks & Singer initialization

Although the present invention has been described in connection with various embodiments, it will be appreciated from the specification that various combinations of elements, variations or improvements therein may be made, and are within the scope of the invention as defined by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCES

[1] H. Lugt, Vortex Flow in Nature and Technology (Wiley, 1972).

[2] S. Robinson, Annual Review Fluid Mechanics 23, 601 (1991).

[3] L. Portela, Ph.D. thesis, Stanford University, California (1997).

[4] V. Kolár, in Proceedings of the 8th WSEAS International Conference on Fluid Mechanics, 8th WSEASInternational Conference on Heat and Mass Transfer (World Scientific and Engineering Academy and Society (WSEAS), Stevens Point, Wis., USA, 2011), FM'11/HMT'11, pp. 23-28, ISBN 978-960-474-268-4, URL http://dl.acm.ord/citation.cfm?id=1959560.1959564.

[5] C. Garth, An introduction to flow visualization (5), http://graphics.cs.ucdavis.edu/˜joy/ecs277/other-notes/ecs277-5.pdf, accessed: 2014 Sep. 9.

[6] M. Jiang, R. Machiraju, and D. Thompson, in The Visualization Handbook (Academic Press, 2005), pp. 295-309.

[7] C. Garth, X. Tricoche, T. Salzbrunn, T. Bobach, and G. Scheuermann, in Proceedings of the Sixth Joint Eurographics—IEEE TCVG Conference on Visualization (Eurographics Association, Aire-la-Ville, Switzerland, 2004), VISSYM'04, pp. 155-164, ISBN 3-905673-07-X.

[8] D. Banks and B. Singer, IEEE Transactions on Visualization and Computer Graphics 1,151 (1995).

The invention is:

1. A computer-aided method suitable for assisting in a design of an object zone subjected to high vorticity and/or low static pressure fields when moving inside a flow field by providing suitable seed points for obtaining vortex core lines in a fluid data model of the environment of said object zone comprising, the method comprising the following steps:
(a) obtaining a dataset of candidate seeds containing all the cells or points satisfying:
(i) a condition dp/dX>dp/dX_{threshold}, wherein dp/dX is a pressure gradient in the direction of the flow and dp/dX_{threshold} is a suitable parameter for the object zone; or
(ii) a condition Cdf>Cdf_{threshold}, wherein Cdf is a drag friction coefficient at solid boundaries and Cdf_{threshold} is a suitable parameter for the object zone, and
(b) updating a previous dataset of candidate seeds with all the cells or points satisfying the equation not used for obtaining the dataset in step a).

2. The computer-aided method according to claim 1, wherein the fluid data model comprises a CFD dataset and/or wind tunnel data and/or experimental volumetric data and/or flow field analytical data.

3. The computer-aided method according to claim 1, wherein the object is an aircraft.

4. The computer-aided method according to claim 3, wherein the object zone is a Counter Rotating Open Rotor (CROR) engine.

5. The computer-aided method according to claim 4, wherein the fluid data model comprises an area covering vortices generated by a blade tip of the first stage of the engine that impact the second stage of the engine.

6. A system comprising a computer memory and processor configured to assist in a design of an object zone subjected to high vorticity when moving in a flow field by providing suitable seed points for obtaining vortex core lines in a fluid data model of the environment of the object zone, the computer memory having stored thereon modules comprising a computer-implemented fluid data model of the environment of the object zone and a computer-implemented module configured to identify cells of points of the object zone satisfying vorticity conditions, wherein the computer-implemented module is configured to perform the identification in the following steps:
(a) obtaining a dataset of candidate seeds containing all the cells or points satisfying:
(i) a condition dp/dX>dp/dX_{threshold}, wherein dp/dX is a pressure gradient in the direction of the flow and dp/dX_{threshold} is a suitable parameter for the object zone; or
(ii) a condition Cdf>Cdf_{threshold}, wherein Cdf is a drag friction coefficient at solid boundaries and Cdf_{threshold} is a suitable parameter for the object zone, and
b) updating a previous dataset of candidate seeds with all cells or points satisfying an equation not used for obtaining the dataset in step a).

7. The system according to claim 6, wherein the fluid model comprises a CFD dataset and/or wind tunnel data and/or experimental volumetric data and/or flow field analytical data.

8. The system according to claim 6, wherein the object is an aircraft.

9. The system according to claim 8, wherein the object zone is a Counter Rotating Open Rotor (CROR) engine.

10. The system according to claim 9, wherein the fluid data model comprises an area covering vortices generated by a blade tip of a first stage of an engine that impact a second stage of the engine.

11. A computer-aided method to assisting in designing of an aircraft component subjected to high vorticity and/or low static pressure fields while moving through a flow field, the method comprising:
providing seeds for points in a fluid data model of vortex core lines generated by the aircraft component moving through the flow field, wherein providing the seeds includes:
(a) obtaining a first dataset of candidate seeds for each of the points satisfying:
(i) a condition dp/dX>dp/dX_{threshold}, wherein dp/dX is a pressure gradient in the direction of flow in the flow field and dp/dX_{threshold} is a predefined threshold level of dp/dX; or
(ii) a condition Cdf>Cdf,_{threshold}, wherein Cdf is a drag friction coefficient at solid boundaries of the aircraft component, and Cdf_{threshold} is a predefined threshold level of Cdf, and
(b) updating a second dataset of candidate seeds for all of the points including the points not used to obtain the first dataset.

12. The computer-aided method of claim 11 wherein the second dataset is a dataset of seeds for the points which is prior to the first dataset.
